(19) United States
(12) Patent Application Publication
(10) Pub. No.: US 2022/0181052 A1
(43) Pub. Date: Jun. 9, 2022

(54) ELECTROMAGNETIC COMPONENT HAVING MAGNETO-DIELECTRIC MATERIAL

(71) Applicant: ROGERS CORPORATION, Chandler, AZ (US)

(72) Inventors: Shawn P. Williams, Andover, MA (US); Yajie Chen, Brighton, MA (US); Kristi Pance, Auburndale, MA (US); Gianni Taraschi, Arlington, MA (US)

(21) Appl. No.: 17/536,372

(22) Filed: Nov. 29, 2021

Related U.S. Application Data
(60) Provisional application No. 63/121,740, filed on Dec. 4, 2020.

(51) Int. Cl. H01F 1/03; H01F 7/06

(52) U.S. Cl. CPC H01F 1/0315; H01F 7/06

(57) ABSTRACT

An electromagnetic, EM, component operational at a defined operating frequency, includes: a body of material having at least one magneto-dielectric material, MDM, with a magnetic material having a relative permeability greater than one and dielectric material having a relative permittivity greater than one, at the defined operating frequency; wherein the magnetic material has one of: a multi-phase crystal structure; or, a non-cubic crystal structure; and, wherein the EM component is at least one of; an EM resonator, and an EM beam shaper.

### CROSS REFERENCE TO RELATED APPLICATIONS

This application claims the benefit of U.S. Patent Application Ser. No. 63/121,740, filed Dec. 4, 2020, which is incorporated herein by reference in its entirety.

### BACKGROUND

The present disclosure relates generally to an electromagnetic, EM, component, and particularly to an EM component comprising a body of material that comprises at least one magneto-dielectric material, MDM.

EM components are useful in at least the field of EM antenna design, where one EM component may form an EM resonator, and another EM component may form an EM beam shaper. Some existing EM components utilize a dielectric material as the main or only constituent to form a dielectric resonator antenna, DRA.

While existing EM antennas utilizing only dielectric materials may be suitable for their intended purpose, the art relating to EM antennas would be advanced with utilization of an EM component comprising a body of material that comprises at least one MDM.

### BRIEF SUMMARY

In an embodiment, an electromagnetic, EM, component operational at a defined operating frequency, includes: a body of material having at least one magneto-dielectric material, MDM, with a magnetic material having a relative permeability greater than one and dielectric material having a relative permittivity greater than one, at the defined operating frequency; wherein the magnetic material has one of: a multi-phase crystal structure; or, a non-cubic crystal structure; and, wherein the EM component is at least one of; an EM resonator, and an EM beam shaper.

An embodiment includes an arrangement of the aforementioned EM component, wherein the at least one MDM comprises a first MDM and a second MDM, the first MDM defining an EM resonator; and further wherein: the second MDM forms an EM beam shaper that substantially covers and embeds EM radiating surfaces of the EM resonator.

An embodiment includes an arrangement of the aforementioned EM component having a first MDM and a second MDM, wherein the at least one MDM further comprises a third MDM that substantially covers outer exposed surfaces of and embeds the second MDM; the third MDM having a third relative permeability that is different from the first relative permeability and the second relative permeability.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures, and where reference to an EM component is in reference to an EM component as disclosed herein:

FIGS. 1A, 1B and 1C, depict an elevation side view, a bottom view (viewed from the bottom up), and a top view (viewed from the top down), respectively, of an EM component having a body of at least one MDM, in accordance with an embodiment;

FIGS. 2A, 2B, 2C, 2D, 2E, 2F, 2G, 2H, 2I and 2J, depict a variety of bodies of at least one MDM of an EM component having a three dimensional, 3D, shape, in accordance with an embodiment;

FIGS. 3A, 3B, 3C, 3D, 3E, 3F, 3G, 3H and 3I, depict another variety of bodies of at least one MDM of an EM component having a three dimensional, 3D, shape, in accordance with an embodiment;

FIGS. 4A, 4B, 4C, 4D, 4E, 4F and 4G, depict corresponding ones of the body of the at least one MDM of FIGS. 2A-2J and 3A-3I having a two-dimensional, 2D, azimuth (x-y plane) cross section shape, in accordance with an embodiment;

FIGS. 5A, 5B, 5C and 5D, depict a body of at least one MDM having a first body portion and a second body portion, in accordance with an embodiment;

FIG. 6A depicts a generic body of at least one MDM having a first body portion, a second body portion, and a third body portion, in accordance with an embodiment;

FIGS. 6B, 6C, 6D and 6E, depict an EM component with a generic body represented by FIG. 6A having an EM signal feed having a loop configuration within an EM resonator formed by a first body portion of the at least one MDM, in accordance with an embodiment;

FIGS. 7A, 7B, 7C, 7D and 7E, depict example EM components with a body of material having at least one MDM having a first body portion and a second body portion disposed on a metallized voltage reference surface and with an EM signal feed, where FIGS. 7A, 7C, 7D and 7E, depict cross section side views through a central x-z plane, and FIG. 7B depicts a top down plan view of FIG. 7A, in accordance with an embodiment;

FIGS. 8A, 8B, 8C, 8D, 8E and 8F, depict example EM components, where FIGS. 8A and 8D depict rotated isometric views, and FIGS. 8B, 8C, 8E and 8F, depict central x-z plane cross section views of the corresponding example EM components, in accordance with an embodiment;

FIG. 9A depicts an analytical model of an example EM component having an EM signal feed with a loop configuration within an EM resonator, in accordance with an embodiment;

FIG. 9B depicts results of analytical modeling showing the magnitude of a resulting E-field distribution pattern through a central x-z plane of the EM component of FIG. 9A through the loop signal feed (along the coupling loop plane), in accordance with an embodiment;

FIG. 10A depicts, similar to FIG. 9A, an analytical model of an example EM component having an EM signal feed with a loop configuration within an EM resonator, in accordance with an embodiment;

FIG. 10B depicts results of analytical modeling showing the magnitude of the resulting E-field distribution pattern through a central y-z plane of the EM component of FIG. 10A through the loop signal feed (orthogonal to the coupling loop plane), in accordance with an embodiment;

FIG. 11 depicts results of analytical modeling showing a resulting E-field distribution pattern through a central x-z plane of an EM component through a partial loop signal feed (along the coupling loop plane) as a comparison to that of FIG. 9B, in accordance with an embodiment;

FIG. 12 depicts results of analytical modeling showing a resulting E-field distribution pattern through a central y-z plane of the EM component of FIG. 11 through the partial loop signal feed (orthogonal to the coupling loop plane) as a comparison to that of FIG. 10B, in accordance with an embodiment;

FIG. 13 depicts an analytical model of an EM component and results of analytical modeling of the analytical model showing a resulting boresight gain in two orthogonal planes associated with a complete continuous signal feed loop of the depicted EM component, in accordance with an embodiment;

FIG. 14 depicts another analytical model of an EM component similar to but different from that of FIG. 13 and results of analytical modeling of the analytical model showing a resulting boresight gain in two orthogonal planes associated with the complete continuous signal feed loop of the depicted EM component, in accordance with an embodiment;

FIG. 15A depicts an analytical model of an EM component similar to that of FIG. 13, but with a third body portion of MDM disposed over and embedding the first and second body portions, in accordance with an embodiment; and

FIG. 15B depicts results of analytical modeling of the analytical model of FIG. 15A showing a resulting magnitude of an E-field distribution in the plane of the loop of the depicted EM signal feed, in accordance with an embodiment.

One skilled in the art will understand the drawings, described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements.

### DETAILED DESCRIPTION

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Accordingly, the following example embodiments are set forth without any loss of generality to, and without imposing limitations upon, the claimed invention disclosed herein.

In general, an embodiment, as shown and described by the various figures and accompanying text, provides an EM component 100 operational at a defined operating frequency having a body 104 of material that includes at least one magneto-dielectric material, MDM, that includes a magnetic material or particles thereof having an average relative permeability greater than one, and a dielectric material having an average relative permittivity greater than one, at the defined operating frequency. In an embodiment, the magnetic material has one of: a multi-phase crystal structure; or, a non-cubic crystal structure. In an embodiment, the EM component 100 is at least one of; an EM resonator 200, and an EM beam shaper 250.

In an embodiment, the magnetic material is other than a single-phase magnetic material. In an embodiment, the magnetic material has a multi-phase crystal structure. In an embodiment, the multi-phase crystal structure is any one of: a cubic structure; a hexagonal structure; or, a mixture of a cubic structure and a hexagonal structure.

In another embodiment, the magnetic material has a single-phase non-cubic crystal structure.

In an embodiment, the magnetic material has a hexaferrite crystal structure. In an embodiment, the magnetic material further has a single-phase hexaferrite crystal structure. In an alternative embodiment, the magnetic material further has a multi-phase hexaferrite crystal structure.

In an embodiment, the magnetic material is dispersed within a polymer dielectric material, or the magnetic material is dispersed within a ceramic dielectric material. In an embodiment, the magnetic material is uniformly dispersed in the dielectric material, or the magnetic material is non-uniformly dispersed in the dielectric material. As will be appreciated, a MDM having uniformly dispersed magnetic particles may be more easily manufactured than one with non-uniformly dispersed magnetic particles, and as will become evident by the description herein below, a MDM having non-uniformly dispersed magnetic particles may offer enhanced performance characteristics than one with uniformly dispersed magnetic particles. As such, fabrication of a particular body 104 of MDM suitable for a purpose disclosed herein may be driven by cost-benefit considerations.

In an embodiment, the MDM is a pure magnetic ceramic, including hexagonal structure ferrites, which may be a single phase structure or a multi-phase structure. In an embodiment, the pure magnetic ceramic includes hexagonal structure ferrites. In an embodiment, the pure magnetic ceramic is a single-phase structure, or the pure magnetic ceramic is a multi-phase structure.

In an embodiment, the EM component 100 includes an EM resonator 200, and the EM resonator 200 is an EM antenna.

In an embodiment, the EM component 100 includes an EM beam shaper 250, and the EM beam shaper 250 is an EM lens.

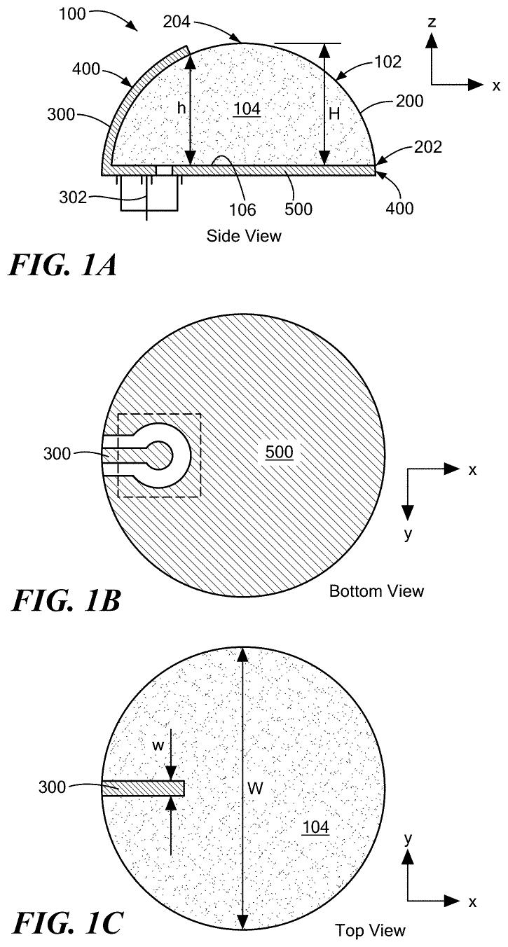

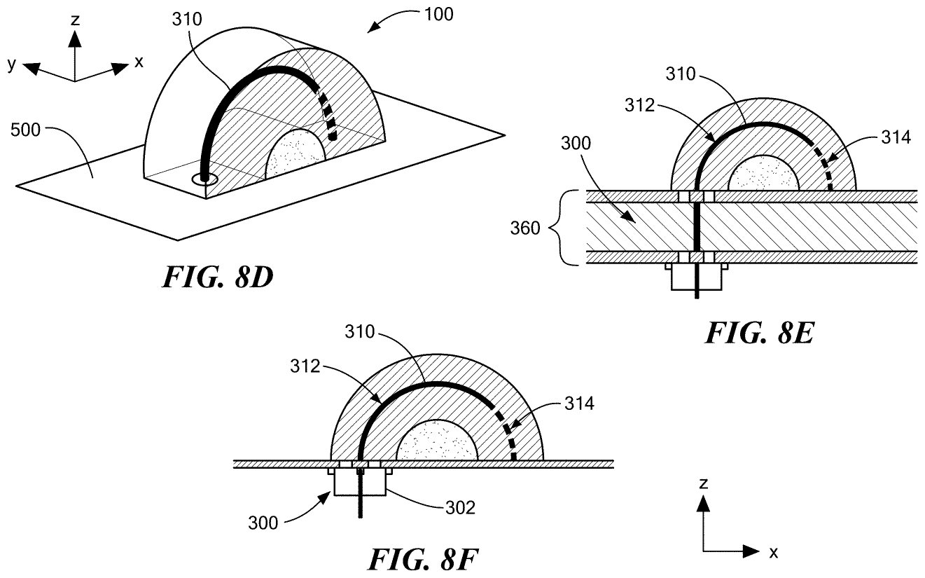

Reference is now made to FIGS. 1A-1C, where FIG. 1A depicts an elevation side view, FIG. 1B depicts a bottom view (viewed from the bottom up), and FIG. 1C depicts a top view (viewed from the top down), of an EM component 100 having an EM resonator 200 and an electrically conductive EM signal feed 300 configured and disposed to electromagnetically excite the EM resonator 200 via the EM signal feed 300. In an embodiment, the EM component 100 has at least one metallized portion 400 disposed on an outer surface 102 of the body 104 of the MDM of the EM component 100, wherein the at least one metallized portion 400 forms the EM signal feed 300. In an embodiment, the at least one metallized portion 400 further forms an electrically conductive voltage reference surface 500 (which may also herein be referred to as a ground plane) that is configured and disposed to electromagnetically cooperate with, and is electrically isolated from (not in direct electrical contact with), the EM signal feed 300. In an embodiment, the EM signal feed 300 is electromagnetically excited via a signal line 302, which may be a coaxial cable or any other signal line suitable for a purpose disclosed herein (discussed further below in connection with FIGS. 8A-8F). In an embodiment, the voltage reference surface 500 is disposed on and substantially, but not completely, covers a bottom surface 106 of the body 104, thereby allowing a portion of the EM signal feed 300 to occupy a portion of the bottom surface 106 of the body 104 along with the voltage reference surface 500. In an embodiment, the EM signal feed 300 extends from an outer perimeter of the bottom surface 106 of the body 104 upward along a side of the outer surface 102 of the body 104 such that in response to the EM signal feed 300 being electromagnetically excited, an electric field, E-field, propagates from the EM signal feed 300 through the body 104 to the voltage reference surface 500. As can be seen in FIG. 1C, the portion of the EM signal feed 300 that extends upward along a side of the outer surface 102 of the body 104 has a width “w” that is substantially less than an overall outside dimension “W” of the EM resonator 200. In an embodiment, w is greater than zero and equal to or less than 1/10^{th} W. In an embodiment, w is equal to or greater than 1/100^{th} W and equal to or less than 1/10^{th} W. In an embodiment, w is equal to or greater than 1/50^{th} W and equal to or less than 1/20^{th} W. In an embodiment, the EM signal feed 300 that extends upward along a side of the outer surface 102 of the body 104 extends from a proximal end 202 of the EM resonator 200 to a height “h” that is proximate a distal end 204 of the EM resonator 200 having a height “H”. In an embodiment, the height “h” is equal to or less than “H” and equal to or greater than 0.75H. In an embodiment, the height “h” is equal to or less than 0.75H and equal to or greater than 0.5H. As used herein, reference to a proximal end and a distal end of a particular feature is with respect to a base and an apex, respectively, of the corresponding feature, where for the above referenced EM resonator 200 the base is at the bottom surface 106 of the body 104. Stated alternatively and with reference to the orthogonal set of x-y-z axes depicted in the various figures, a direction from the proximal end to the distal end of a particular feature is in a direction parallel to the corresponding z-axis.

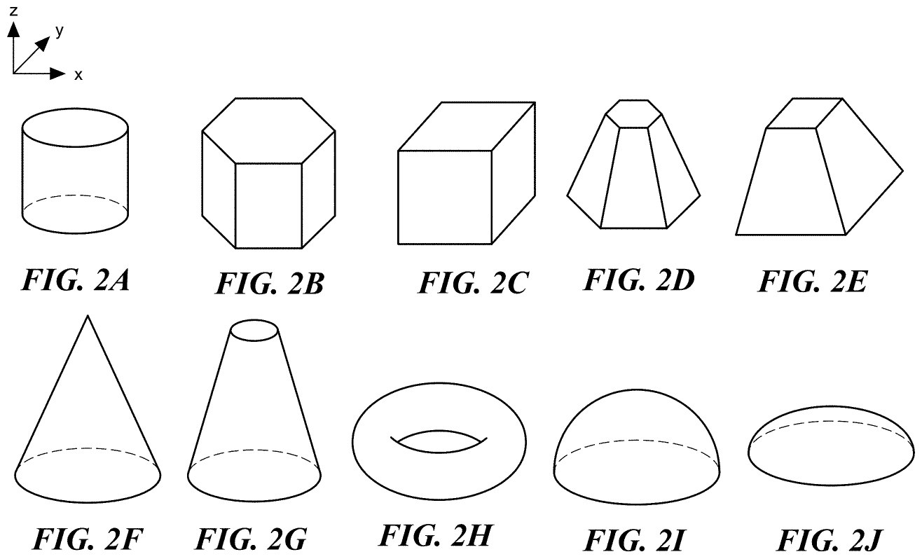

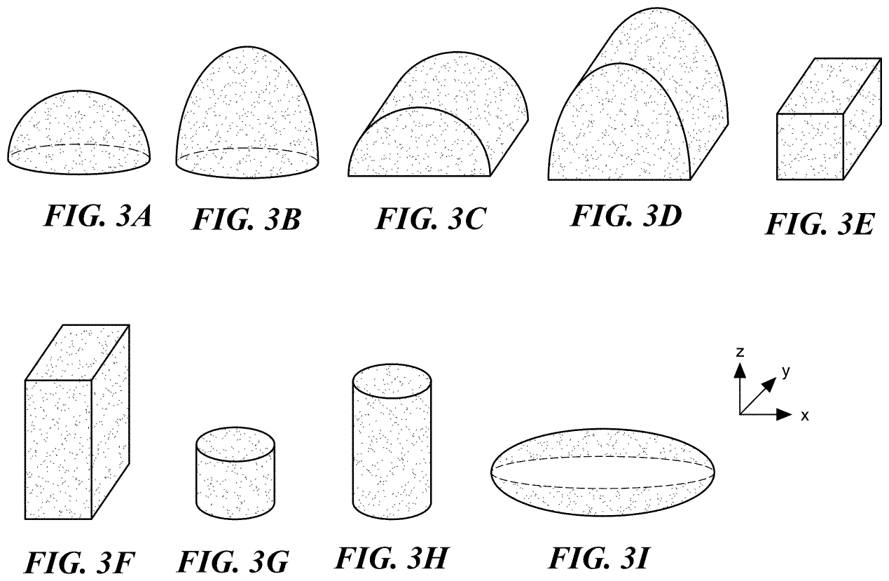

Reference is now made to FIGS. 2A-2J and 3A-3I. While FIGS. 1A-1C depict the body 104 of the at least one MDM having a three dimensional, 3D, shape in the form of a hemisphere, it will be appreciated that an embodiment is not limited to such shape but may have any 3D shape suitable for a purpose disclosed herein, such as but not limited to: a solid cylinder (FIGS. 2A, 2B, 2C, 3C, 3D, 3E, 3F, 3G, 3H); a cylinder having a circular cross section (FIGS. 2A, 3G, 3H); a cylinder having a non-circular cross section (FIGS. 2B, 2C, 3C, 3D, 3E, 3F); a cylinder having an ellipsoidal cross section (FIGS. 2A, 3G, 3H, but ellipsoidal in x-y cross section); a cylinder having a rectangular cross section (FIGS. 2C, 3E, 3F); a cylinder having a square cross section (FIGS. 2C, 3E, 3F); a polygonal pyramid (FIGS. 2D, 2E, 3E, 3F); a truncated polygonal pyramid (FIGS. 2D, 2E); a cone (FIG. 2F); a truncated cone (FIG. 2G); a toroid (FIG. 2H); a dome (FIGS. 2I, 2J, 3A, 3B); an elongated dome (FIG. 2I, but elongated in z-direction from base to apex, 3B); a dome with an ellipsoidal x-y cross section (FIG. 2J); a truncated dome (FIG. 2I, but truncated in x-y plane proximate the apex); a hemisphere (FIGS. 2I, 3A); a vertically oriented elongated ellipsoid (FIG. 2I, but elongated in z-direction in the form of an ellipsoid, 3B,); an inverted truncated cone (FIG. 2G, but inverted); an inverted truncated polygonal pyramid (FIGS. 2D, 2E, but inverted); or, an ellipsoid (FIG. 3I).

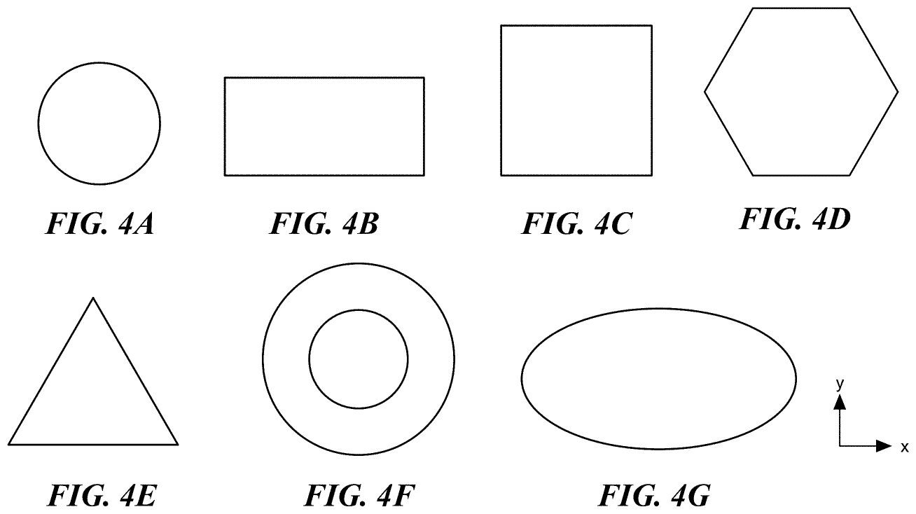

Reference is now made to FIGS. 4A-4G. Further to the foregoing description of 3D shapes, an embodiment of the body 104 of the at least one MDM may also have a two-dimensional, 2D, azimuth (x-y plane) cross section shape in any form suitable for a purpose disclosed herein, such as but not limited to any one of: an ellipse (FIGS. 4A, 4G); a circle (FIG. 4A); a polygon (FIGS. 4B, 4C, 4D, 4E); a rectangle (FIGS. 4B, 4C); a square (FIG. 4C); a hexagon (FIG. 4D); a triangle (FIG. 4E); an annular ring (FIG. 4F); or, an ellipse (FIG. 4G).

It will be noted that FIGS. 3A-3I depict the 3D shapes with “dotted” fill that is uniformly distributed, which is representative of the MDM being composed of magnetic material (illustrative dots) uniformly distributed in dielectric material (regions absent of illustrative dots). Such illustration of the MDM may be carried over to any body 104 of MDM depicted herein whether or not such depiction is illustrated with “dotted” fill, see FIGS. 2A-2J for example. Furthermore, and consistent with descriptions of embodiments disclosed herein, the “dotted” fill of the body 104 of MDM may be non-uniformly distributed, which would be representative of the MDM being composed of magnetic material (illustrative dots) non-uniformly distributed in dielectric material (regions absent of illustrative dots).

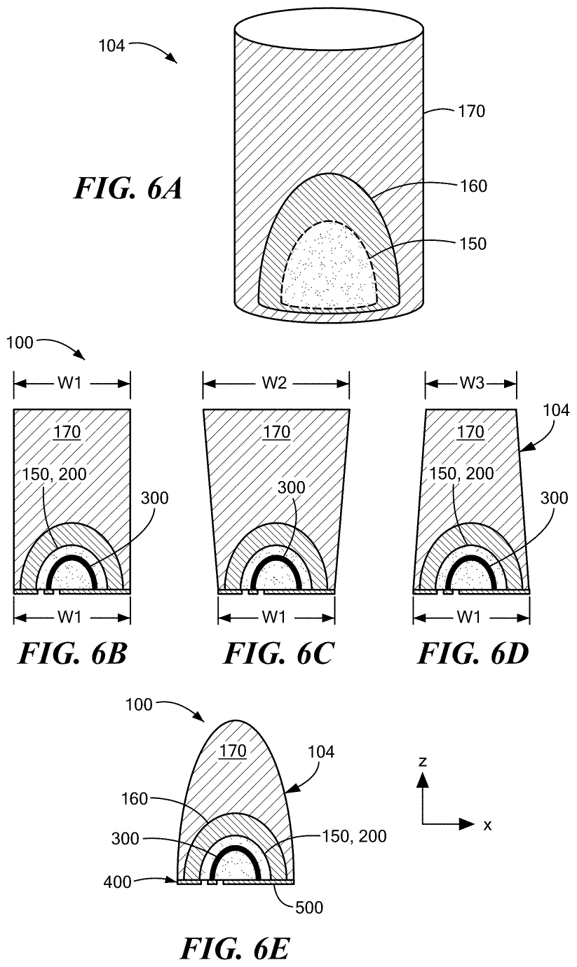

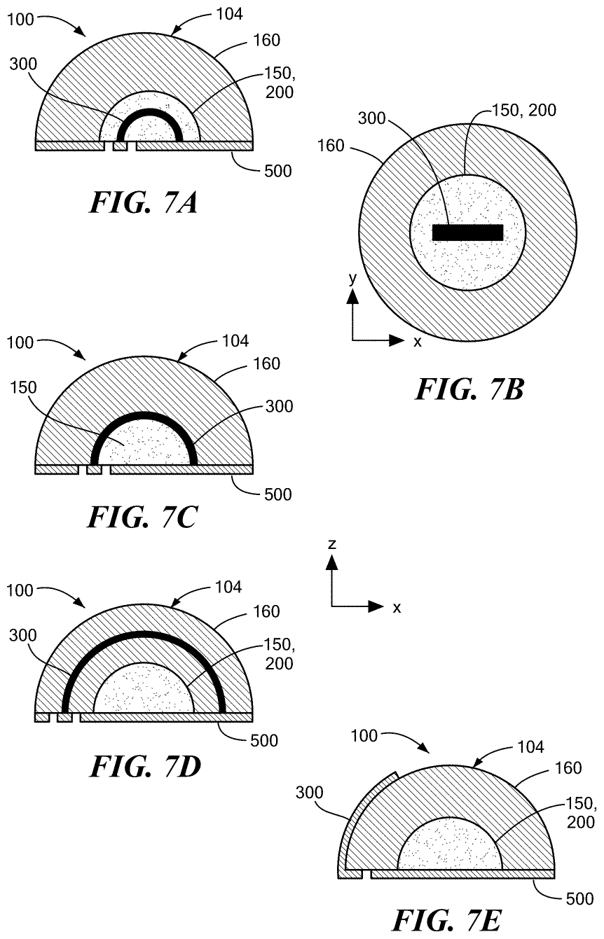

In an embodiment, the body 104 of the at least one MDM is configured as an EM resonator 200 so as to receive an EM signal productive of a magnetic field, H-field, wherein the magnetic material is non-uniformly dispersed within the dielectric material, and the non-uniformly dispersed magnetic material is more heavily loaded in a region of the body 104 having a relatively higher concentration of the magnetic field as compared to a region of the body 104 having a relatively lower concentration of the magnetic field, in response to the body being electromagnetically excited by the EM signal at a defined operating frequency. See FIGS. 6B-6D for example (discussed further herein below) that depict an EM component 100 with an EM signal feed 300 having a loop configuration within the EM resonator 200. In this example embodiment, the magnetic material of the EM resonator 200 could be, and in an embodiment is, more heavily loaded in the body 104 inside (underneath) the loop of the EM signal feed 300 where the concentration of the magnetic field would be relatively higher as compared to outside (above) the loop of the EM signal feed 300. In an embodiment, the defined operating frequency is suitable for a 5G application. In an embodiment, the defined operating frequency is any frequency in the range from 100 MHz (Mega Hertz) to 5 GHz (Giga Hertz). In an embodiment, the defined operating frequency is any frequency in the range from 3 GHz to 5 GHz. In an embodiment, the defined operating frequency is any frequency in the range from 100 MHz to 1 GHz. In an embodiment, the defined operating frequency is any frequency in the range from 0.6 GHz to 0.8 GHz, or from 2.3 GHz to 2.7 GHz, or from 3.2 GHz to 4.9 GHz.

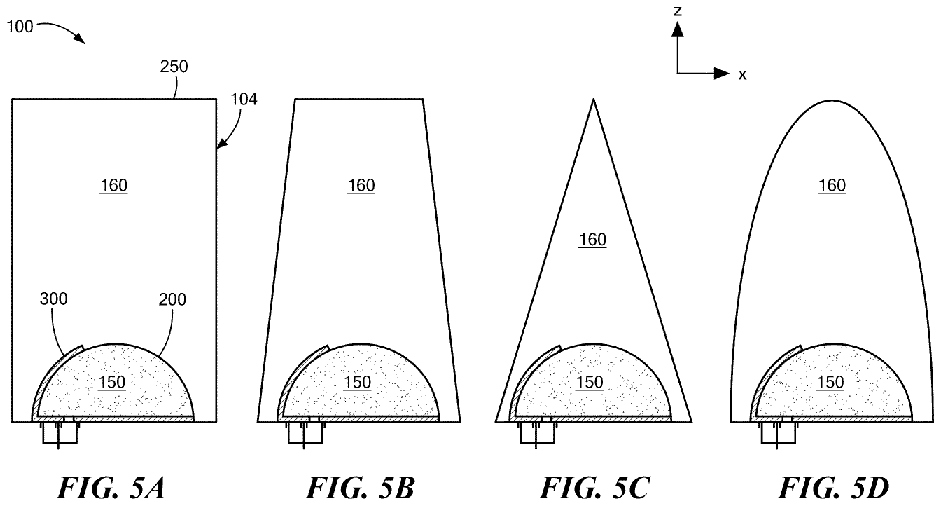

Reference is now made to FIGS. 5A-5D where the body 104 of the at least one MDM includes a first body portion 150 that is a first MDM (also herein referred to by reference numeral 150) configured and formed as an EM resonator 200, and a second body portion 160 that is a second MDM (also herein referred to by reference numeral 160) configured and formed as an EM beam shaper 250. As can be seen in FIGS. 5A-5D various x-z cross sections shapes are depicted for the EM beam shaper 250, such as: rectangular (FIG. 5A); trapezoidal (FIG. 5B); triangular (FIG. 5C); or, ellipsoidal (FIG. 5D). In an embodiment, the second MDM 160 may have any 3D shape suitable for a purpose disclosed herein, such as any 3D shape depicted in FIGS. 2A-2J and 3A-3I for example, and any 2D x-y cross section shape suitable for a purpose disclosed herein, such as any 2D shape depicted in FIGS. 4A-4G for example. In an embodiment, the second MDM 160 that forms an EM beam shaper 250 substantially covers and embeds EM radiating surfaces of the EM resonator 200. As used herein, the phrase substantially covers is intended to encompass 100% complete coverage, and to encompass coverage with the exception of manufacturing tolerances or small deviations from 100% coverage having no measurable effect on overall performance within a determinable statistical window of certainty. While FIGS. 5A-5D depict an EM signal feed 300 having a defined configuration, it will be appreciated that a scope of the invention disclosed herein is not so limited and that any EM signal feed suitable for a purpose disclosed herein and falling within an ambit of the appended claims is contemplated and inherently disclosed herein. Example alternative EM signal feeds 300 are discussed further herein below with reference to FIGS. 8A-8F.

In an embodiment, the first MDM 150 of the EM resonator 200 has a first relative permeability, and the second MDM 160 of the EM beam shaper 250 has a second relative permeability that is different from the first relative permeability. In an embodiment, the first relative permeability is greater than the second relative permeability. As used herein, and unless otherwise stated, reference to a relative permeability is reference to an average relative permeability, and reference to a relative permittivity is reference to an average relative permittivity.

Reference is now made to FIGS. 6A-6E, where FIG. 6A depicts a generic body 104 of material that may have at least one MDM having a first body portion 150 (a first MDM also herein referred to by reference numeral 150), a second body portion 160 (that may be a second MDM also herein referred to by reference numeral 160), and a third body portion 170 that may be a third MDM (also herein referred to by reference numeral 170), where the third body portion 170 substantially covers outer exposed surfaces of and embeds the second body portion 160, and where the second body portion 160 substantially covers outer exposed surfaces of and embeds the first body portion 150. In an embodiment, the third MDM 170 has a third relative permeability that is different from the first relative permeability and the second relative permeability. In an embodiment, the third relative permeability is less than the second relative permeability. As can be seen in FIGS. 6A-5E various x-z cross sections shapes are depicted for the third body portion 170, such as: rectangular (FIGS. 6A, 6B); trapezoidal that flares outward from bottom to top where W2>W1 (FIG. 6C); trapezoidal that flares inward from bottom to top where W3<W1 (FIG. D); or, elongated dome (FIG. 6E). In an embodiment, the third MDM 170 may have any 3D shape suitable for a purpose disclosed herein, such as any 3D shape depicted in FIGS. 2A-2J and 3A-3I for example, and any 2D x-y cross section shape suitable for a purpose disclosed herein, such as any 2D shape depicted in FIGS. 4A-4G for example.

As will be appreciated by a full and complete reading of the entire written description provided herein, reference to the first MDM 150, the second MDM 160, and the third MDM 170, are more generally referred to herein as a first body portion 150, a second body portion 160, and a third body portion 170, respectively, of the body 104 of material of at least one MDM.

Similar to FIGS. 1A-1C, FIGS. 6B-6E (with particular reference here to enumerated FIG. 6E) depict a metallized portion 400 that forms a voltage reference surface 500 that is configured and disposed to electromagnetically cooperate with, and is electrically isolated from, an EM signal feed 300, where here the EM signal feed 300 has a loop configuration and is embedded within the EM resonator 200. Similar to other embodiments disclosed herein, an EM signal when present in the EM resonator 200 via the EM signal feed 300 is productive of a magnetic field that is concentrated in the EM resonator 200. As can be seen in FIGS. 6B-6E, an embodiment includes an arrangement where the EM signal feed 300 is disposed inside the first MDM 150 of the EM resonator 200.

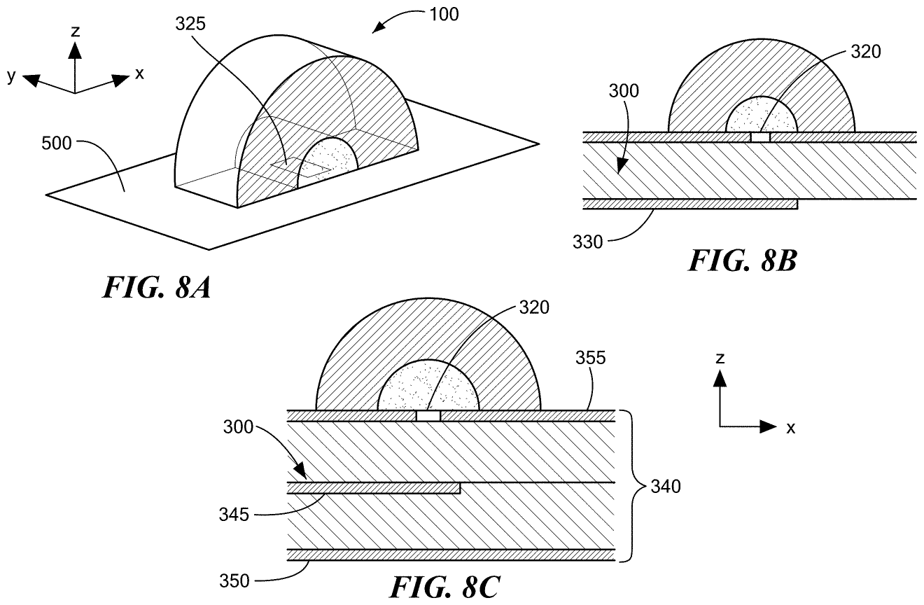

Reference is now made to FIGS. 7A-7E, where each figure depicts an example EM component 100 with a body 104 of material having at least one MDM having a first body portion 150 (a first MDM 150) and a second body portion 160 (herein a second MDM 160) disposed on a metallized reference voltage surface 500 with an EM signal feed 300 configured and disposed to electromagnetically excite the first MDM 150 and EM resonator 200 when an electrical signal is present on the EM signal feed 300, and where FIGS. 7A, 7C, 7D and 7E, depict cross section side views through a central x-z plane, and FIG. 7B depicts a top down plan view of FIG. 7A. Similar to FIGS. 6B-6E, the embodiment of FIG. 7A has an arrangement where the EM signal feed 300 is disposed inside the first MDM 150. In an alternative embodiment and as depicted in FIG. 7C, an embodiment has an arrangement where the EM signal feed 300 is disposed at a boundary of the first MDM 150 and the second MDM 160. In another alternative embodiment and as depicted in FIG. 7D, an embodiment has an arrangement where the EM signal feed 300 is disposed inside the second MDM 160. In yet another alternative embodiment and as depicted in FIG. 7E, an embodiment has an arrangement where the EM signal feed 300 is disposed on an outer surface of the second MDM 160. Similar to other embodiments disclosed herein, an EM signal when present in the EM resonator 200 (first MDM 150) via the EM signal feed 300 is productive of a magnetic field that is concentrated in the EM resonator 200 (first MDM 150). In the embodiment depicted in FIG. 7A, the magnetic field is concentrated in the inner core of the first MDM 150 underneath the loop of the EM signal feed 300; in the embodiment depicted in FIG. 7C, the magnetic field is concentrated in a majority of the first MDM 150 underneath the loop of the EM signal feed 300; in the embodiment depicted in FIG. 7D, the magnetic field is concentrated in a majority of the first MDM 150 and a portion of the second MDM 160 underneath the loop of the EM signal feed 300; and, in the embodiment depicted in FIG. 7E, the magnetic field is concentrated in majorities of the first MDM 150 and the second MDM 160 underneath the portion of the EM signal feed 300 illustrated.

As will be appreciated by comparing the placement of the EM signal feed 300 within the body 104 of material having at least one MDM of the embodiments depicted in FIGS. 7A-7E, EM performance of the EM component 100 will be impacted by such placement, where the embodiment of FIG. 7A will provide the greatest coupling of EM energy within the EM resonator 200, and the embodiment of FIG. 7E will provide the weakest coupling of EM energy within the EM resonator 200, resulting in greater performance in the embodiment of FIG. 7A as compared to the embodiment of FIG. 7E. Conversely, it will be appreciated that the embodiment of FIG. 7E may be easier to manufacture than the embodiment of FIG. 7A, resulting in a potential tradeoff of performance versus manufacturability.

As will be further appreciated, the concentration of the magnetic field arising from the EM signal feed 300 can be influenced by the concentration and dispersion of magnetic material within the first MDM 150, and within the second body portion 160 when present as a MDM. For example, a higher concentration of magnetic material in the first MDM 150 as compared to the second MDM 160 will result in a magnetic field that is concentrated more in the first MDM 150 than in the second MDM 160 for any configuration of embodiments depicted in FIGS. 7A-7E. As a further example, a non-uniformly dispersed concentration of magnetic material in the first MDM 150 of FIG. 7A with the higher concentration being underneath the loop of the EM signal feed 300 will result in a magnetic field that is efficiently concentrated in the inner core of the first MDM 150 underneath the loop of the EM signal feed 300.

By selectively choosing the placement of the EM signal feed 300 relative to the first and second MDMs 150, 160, along with the concentration and dispersion of magnetic material within the first and second MDMs 150, 160, both the performance and manufacturability of the EM component 100 can be managed and tailored for optimum cost-benefit performance.

With reference to any of the foregoing figures, but with particular reference to FIGS. 5A-5D, 6A-6E and 7A-7E, the magnetic material of the second MDM 160 may be uniformly dispersed within the associated dielectric material of the second MDM 160, or the magnetic material of the second MDM 160 may be non-uniformly dispersed within the associated dielectric material of the second MDM 160, with a higher concentration of magnetic particles being disposed in a region of a higher H-field concentration; and, the magnetic material of the third MDM 170 may be uniformly dispersed within the associated dielectric material of the third MDM 170, or the magnetic material of the third MDM 170 may be non-uniformly dispersed within the associated dielectric material of the third MDM 170, with a higher concentration of magnetic particles being disposed in a region of a higher H-field concentration.

While an example EM signal feed 300 has been disclosed and illustrated herein being fed by a coaxial signal line 302, it will be appreciated that a scope of the invention is not so limited and that any signal feed suitable for a purpose disclosed herein may be employed and considered to fall within a scope of an invention disclosed here. Such alternative example EM signal feeds will now be discussed with reference to FIGS. 8A-8F, where FIGS. 8A and 8D depict rotated isometric views, and FIGS. 8B, 8C, 8E and 8F, depict central x-z plane cross section views, of a corresponding example EM component 100.

FIGS. 8A and 8B in combination depict an EM component 100 having an EM signal feed 300 that includes an aperture feed 320 that may further include a slot 325 with a conductive line 330 disposed under and oriented orthogonal to the slot 325. Alternatively, FIGS. 8A and 8C in combination depict an EM component 100 having an EM signal feed 300 that includes a stripline 340 having a microstrip 345 disposed between a lower electrically conductive surface 350 and an upper electrically conductive surface 355 with an aperture 320 or slot 325 disposed in the upper electrically conductive surface 355 above and orthogonal to the microstrip 345. FIGS. 8D and 8E in combination, and FIGS. 8D and 8F in combination, depict an EM component 100 having an EM signal feed 300 that includes a coupling loop 310 that may be electromagnetically excited by a waveguide 360 (FIG. 8E), or a coaxial signal line 302 (FIG. 8F). In an embodiment, and while not explicitly illustrated, the waveguide 360 may be a substrate integrated waveguide (SIW) having a structure well known in the art.

With respect to FIGS. 8D-8F, it will be noted that the EM signal feed 300 in the form of a coupling loop 310 is depicted in both solid line 312 and dashed line 314 fashion, which is representative of the coupling loop 310 being either a partial loop (represented by reference numeral 312), or a complete continuous loop (represented by reference numerals 312 and 314 in combination). In an embodiment, the coupling loop 310 is physically and electrically connected the signal feed 300 at one end of the coupling loop 310, and is physically and electrically connected to the voltage reference surface 500 at the other opposing end of the coupling loop 310.

In an example EM component 100 as disclosed herein, the body 104 of material having at least one MDM, which may have a first MDM 150, a first MDM 150 and a second MDM 160, or a first MDM 150, a second MDM 160 and a third MDM 170, may be configured to form an EM resonator, an EM beam shaper, or a combination of an EM resonator and an EM beam shaper, depending on the presence and placement of an EM signal feed 300. For example, an embodiment includes an arrangement where: the first MDM 150 is configured as an EM resonator; the second MDM 160 is configured as an EM resonator; the second MDM 160 is configured as an EM beam shaper 250 and not as an EM resonator; the third MDM 170 is configured as an EM beam shaper and not as an EM resonator; or, the entire EM component is configured as an EM beam shaper and not as an EM resonator. Any and all combinations of the foregoing are contemplated and considered to fall within an ambit of the appended claims.

In an example EM component 100 where at least one of the aforementioned MDMs defines and is configured as an MDM resonator (that is, an EM resonator defined by the at least one MDM), the example EM component 100 further includes an EM beam shaper that substantially covers and embeds all EM radiating surfaces of the MDM resonator, and the EM beam shaper comprises a dielectric material having a dielectric constant equal to or greater than 20, where in an embodiment the EM beam shaper is absent a magnetic material dispersed within the dielectric material. That is, an embodiment includes an arrangement where the EM beam shaper is an all-dielectric material.

In an example EM component 100 as disclosed herein, the body 104 of material having at least one MDM, which includes any one of the first MDM 150, the second MDM 160, and the third MDM 170, has an average relative permeability greater than one and equal to or less than 3, and an average relative permittivity greater than one and equal to or less than 15; or, an average relative permeability greater than one and equal to or less than 2.5, and an average relative permittivity greater than one and equal to or less than 7.

From the foregoing descriptions of structure of an EM component 100, it will be appreciated that the body 104 of material having at least one MDM may be made by a variety of manufacturing processes, such as by a method of molding, by a method of resin casting, or by a method of 3D printing. With respect to the method of molding, the method of molding may include any one or more of the following methods: injection molding; compression molding; and, transfer molding. With respect to the method of 3D printing, the method of 3D printing may include at least one of stereolithography (SLA) printing, and filament printing.

In an example EM component 100 as disclosed herein having at least one metallized portion 400 (see FIGS. 1A-1C for example), the at least one metallized portion 400 may be formed using laser direct structuring, LDS, or may be formed using molded interconnect device (MID) technology.

Additionally, in an example EM component 100 as disclosed herein having an EM signal feed 300, the EM signal feed 300 may be made by any one or more of the following methods: molded interconnect device (MID) technology, and laser direct structuring, LDS.

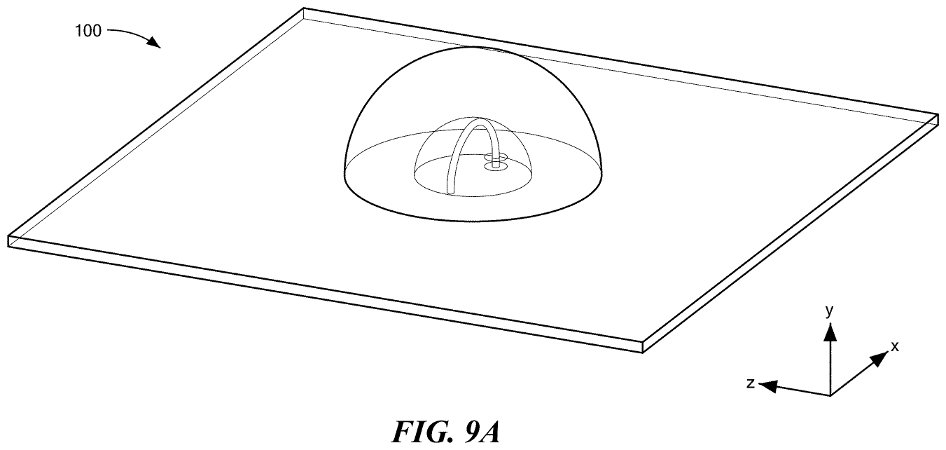

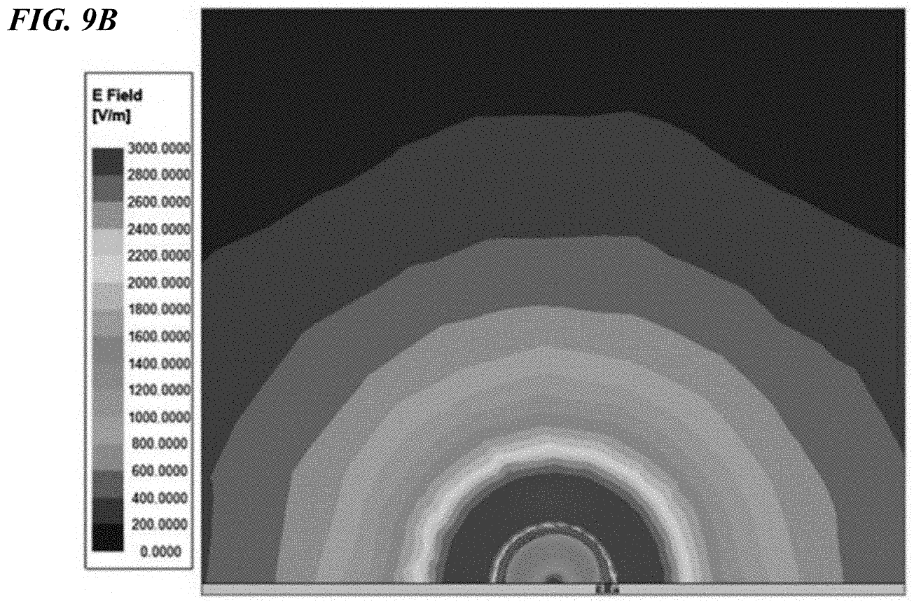

Reference is now made to FIGS. 9A, 9B, 10A, 10B, 11-14, 15A and 15B, which relate to analytical modeling of example EM components 100 as disclosed herein depicting the E-field strength in Volts/meter (V/m) for a given associated structure.

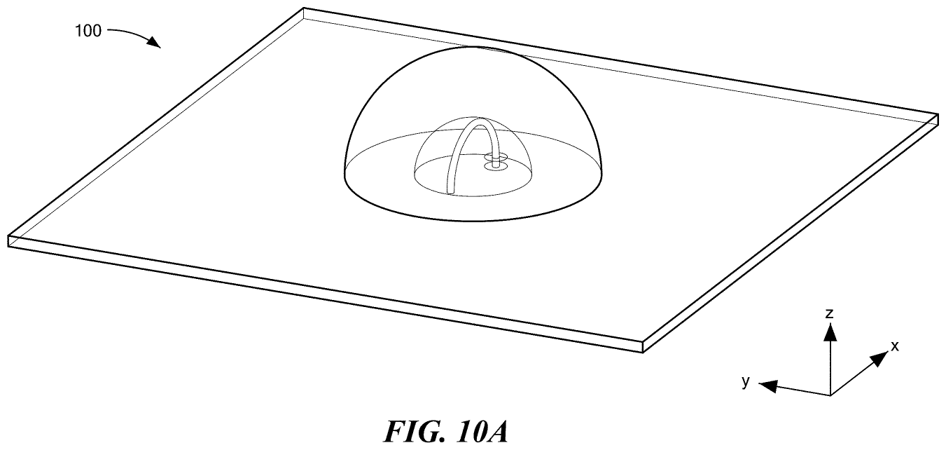

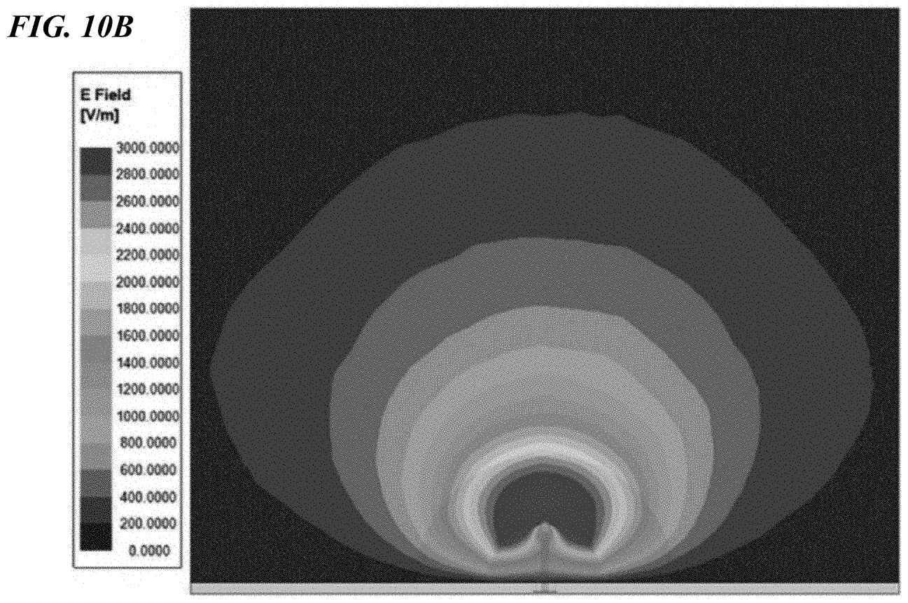

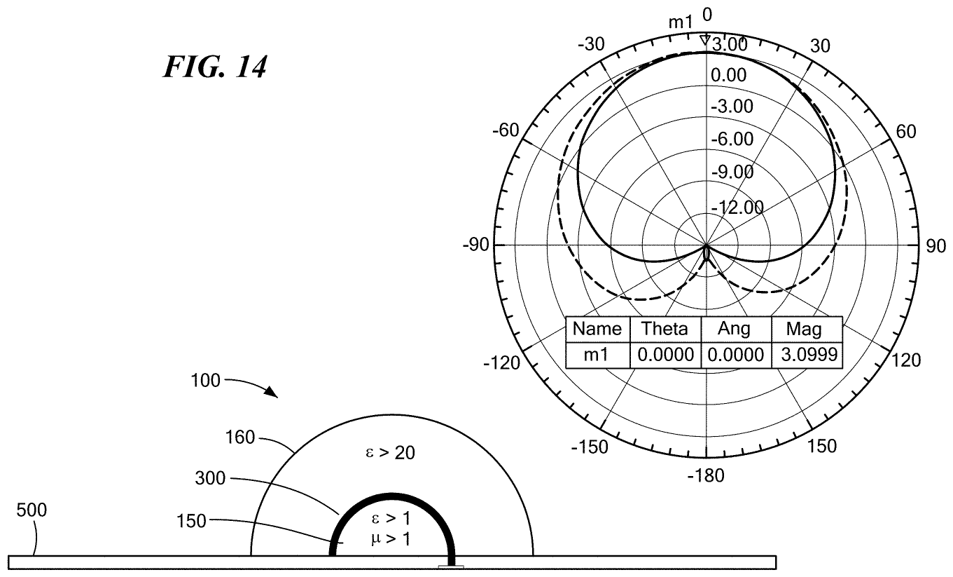

FIGS. 9A and 10A depict an example EM component 100 having an EM signal feed 300 with a loop configuration within an EM resonator 200 similar to that depicted in FIG. 7C where the loop is disposed close to or at the outer boundary of the first body portion 150 that is a first MDM as disclosed herein, and where the second body portion 160 is a dielectric medium absent magnetic particles dispersed therein and having a dielectric constant, Dk, of greater than 20 (see FIG. 14 for example). FIG. 9B depicts the magnitude of a resulting E-field distribution pattern through a central x-z plane of the EM component 100 through the loop signal feed (along the coupling loop plane), and FIG. 10B depicts the magnitude of the resulting E-field distribution pattern through a central y-z plane of the EM component 100 through the loop signal feed (orthogonal to the coupling loop plane). As can be seen, the resulting E-field distribution is concentrated above or outside of the loop EM signal feed 300, which is influenced by the MDM of the first body portion 150 and the dielectric-only Dk material of the second body portion 160, and the presence of the loop EM signal feed 300 disposed therebetween. Such an arrangement concentrates the resulting magnetic field inside the loop EM signal feed 300, and inside the associated first MDM 150, which in this embodiment is an EM resonator 200.

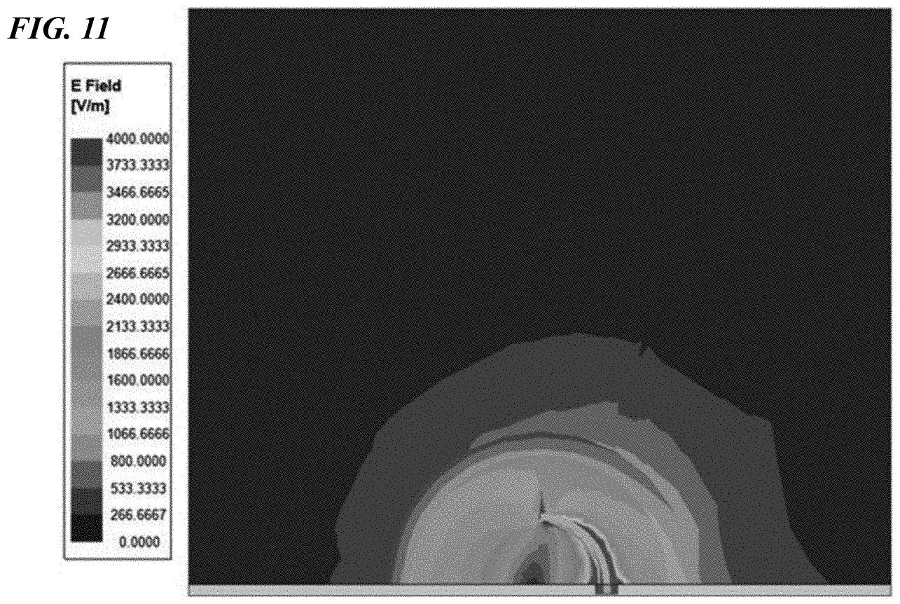

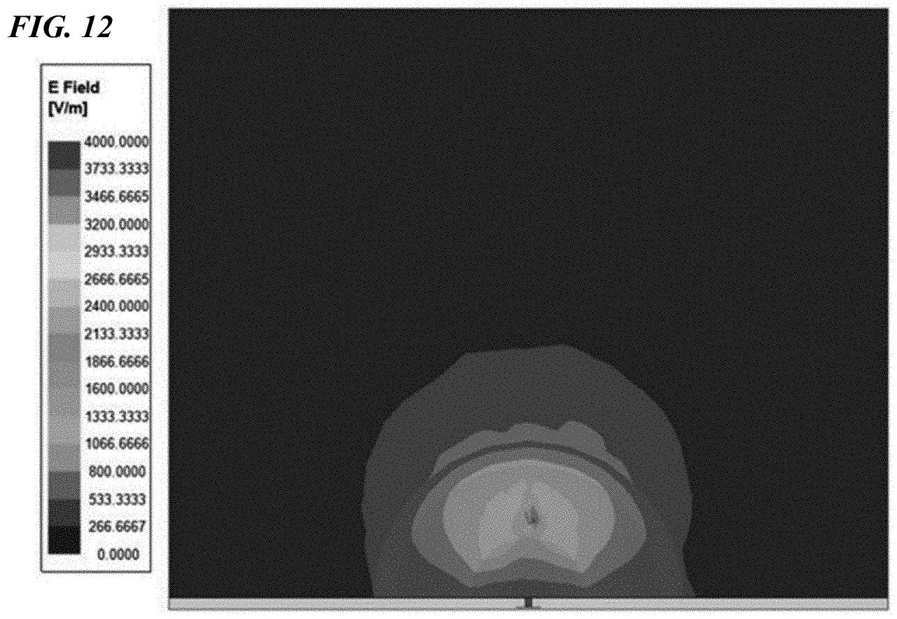

Reference is now made to FIGS. 11 and 12, where both figures depict the magnitude of a resulting E-field distribution pattern of an example EM component 100 having an EM signal feed 300 with a partial loop configuration (see partial loop 312 depicted in FIGS. 8D-8F for example) within an EM resonator 200 (see FIG. 7C where the loop is disposed close to or at the outer boundary of the first body portion 150, as described above). FIG. 11 depicts a resulting E-field distribution pattern through a central x-z plane of the EM component 100 through the partial loop signal feed 312 (along the coupling loop plane, compare to FIG. 9B), and FIG. 12 depicts the resulting E-field distribution pattern through a central y-z plane of the EM component 100 through the partial loop signal feed 312 (orthogonal to the coupling loop plane, compare to FIG. 10B). As can be seen by comparing the E-field distributions of FIGS. 11 and 12 with those of FIGS. 9B and 10B, the partial loop signal feed 312 results in a lesser degree of electromagnetic coupling than does the complete continuous loop signal feed 312 plus 314.

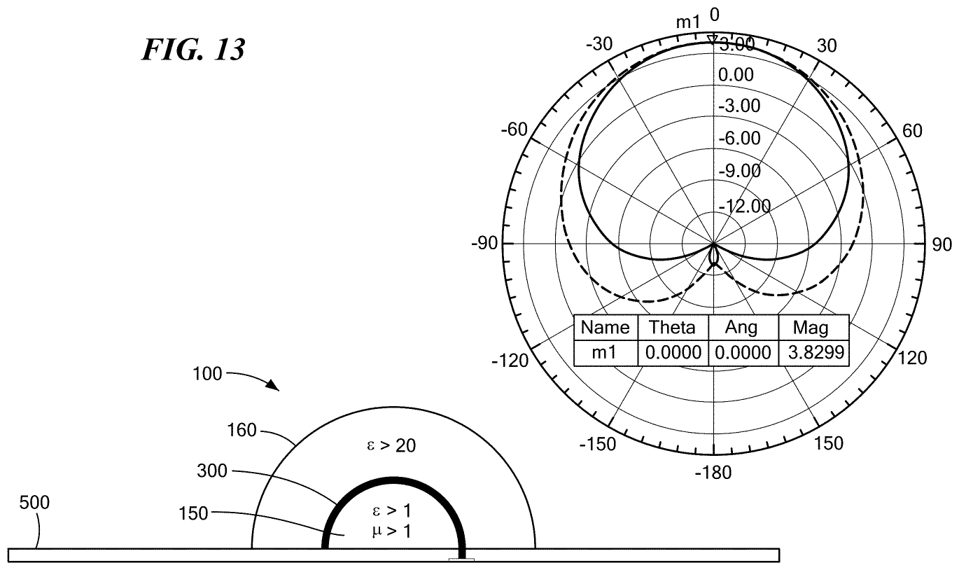

Reference is now made to the example analytical model EM component 100 of FIGS. 13 and 14, where the first body portion 150 is a first MDM having an average relative permeability greater than one and an average relative permittivity greater than one, where the second body portion 160 is a dielectric-only material having an average Dk greater than 20, where a complete continuous signal feed loop 300, 312 plus 314, is employed, where the geometric structure of the respective first body portions 150 are the same in FIGS. 13 and 14, and where the geometric structure of the respective second body portions 160 are the same in FIGS. 13 and 14. For the simulation of the analytical models depicted in FIGS. 13 and 14, the actual relative permeability and relative permittivity values for the first body portion 150 were 7 and 20, respectively.

FIG. 13 depicts gain in dBi in two orthogonal planes: the “solid line” curve is gain in a plane cut parallel to and through the feed loop 300; and the “dashed line” curve is gain in a plane cut perpendicular to and through a center of the feed loop 300. In the embodiment of FIG. 13, the complete continuous signal feed loop 300, 312 plus 314, is disposed proximate the boundary of the first body portion 150 and the second body portion 160 but embedded within the second body portion 160, resulting in a boresight gain of 3.8299 dBi, where the boresight gain is normal to the ground plane 500 and denoted as ml in the illustrated gain curves of FIG. 13.

FIG. 14 depicts gain in dBi in two orthogonal planes: the “solid line” curve is gain in a plane cut parallel to and through the feed loop 300; and the “dashed line” curve is gain in a plane cut perpendicular to and through a center of the feed loop 300. In the embodiment of FIG. 14, the complete continuous signal feed loop 300, 312 plus 314, is disposed proximate the boundary of the first body portion 150 and the second body portion 160 but embedded within the first body portion 150, resulting in a boresight gain of 3.0999 dBi, where the boresight gain is normal to the ground plane 500 and denoted as ml in the illustrated gain curves of FIG. 14. As can be seen by comparing the boresight gains of FIGS. 13 and 14, an analytical improvement in gain of 23.5% is realized by disposing the signal feed so that all of the MDM of the first body portion 150 is subjected to the H-field originating from the loop signal feed 300 (312 plus 314).

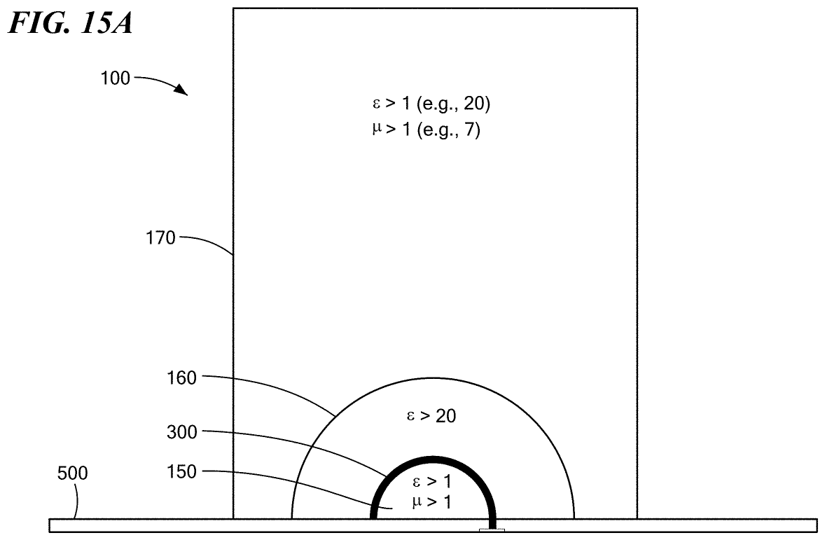

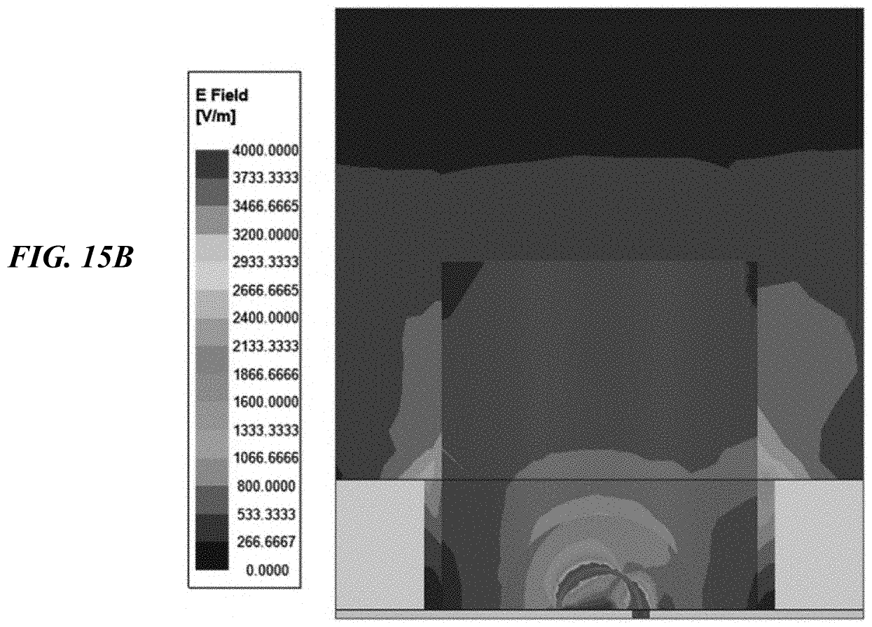

Reference is now made to FIGS. 15A and 15B. FIG. 15A depicts an EM component similar to that of FIG. 13, but with a third body portion 170 of MDM, an MDM lens, disposed over and embedding the first and second body portions 150, 160, where the MDM of the third body portion 170 has an average relative permeability equal to 7 (in general greater than one) and an average relative permittivity equal to 20 (in general greater than 1). In the embodiment depicted in FIG. 15A, the first body portion 150 is disposed and configured to function as an EM resonator, the second body portion 160 is disposed and configured to function as an EM beam shaper (or lens), and the third body portion 170 is additionally disposed and configured to function as an EM beam shaper (or lens). FIG. 15B depicts the magnitude of an E-field distribution in the plane of the loop of the EM signal feed 300. As can be seen by comparing the E-field distribution of FIG. 15B with that of FIG. 9B, the presence of the third body portion 170 has the effect of guiding the electromagnetic wave, as illustrated in the E-field of FIG. 15B.

With respect to the foregoing description of structure for an example EM component 100, it will be appreciated that while there may be a multitude of materials, dielectrics and magneto-dielectrics, that may be suitable for a purpose disclosed herein, there may be certain material properties that may be more effective than others in producing a desired EM radiation pattern. Example materials for an MDM for a purpose disclosed herein include, but are not limited to, the following:

Material-A: An MDM having a polymer based dielectric material having an average relative permittivity of 6.2, and particles of a magnetic material, uniformly or non-uniformly dispersed within the dielectric material, having an average relative permeability of 2.6, having a magnetic loss tangent of 0.03, having an electric loss tangent of 0.004, and having electromagnetic characteristics suitable for use in an EM component 100 as disclosed herein at a range of operating frequencies from equal to or greater than 500 MHz to equal to or less than 1.5 GHz.

Material-B: An MDM having a polymer based dielectric material having an average relative permittivity of 6.4, and particles of a magnetic material, uniformly or non-uniformly dispersed within the dielectric material, having an average relative permeability of 2.05, having a magnetic loss tangent of 0.017, having an electric loss tangent of 0.003, and having electromagnetic characteristics suitable for use in an EM component 100 as disclosed herein at a range of operating frequencies from equal to or greater than 500 MHz to equal to or less than 1.5 GHz.

Material-C: An MDM having a polymer based dielectric material having an average relative permittivity of 6.4, and particles of a magnetic material, uniformly or non-uniformly dispersed within the dielectric material, having an average relative permeability of 1.80, having a magnetic loss tangent of 0.023, having an electric loss tangent of 0.003, and having electromagnetic characteristics suitable for use in an EM component 100 as disclosed herein at a range of operating frequencies from equal to or greater than 1 GHz to equal to or less than 2 GHz.

Material-D: An MDM having a polymer based dielectric material having an average relative permittivity of 6.4, and particles of a magnetic material, uniformly or non-uniformly dispersed within the dielectric material, having an average relative permeability of 1.85, having a magnetic loss tangent of 0.033, having an electric loss tangent of 0.003, and having electromagnetic characteristics suitable for use in an EM component 100 as disclosed herein at a range of operating frequencies from equal to or greater than 1 GHz to equal to or less than 2.5 GHz.

Material-E: An MDM having a ceramic based dielectric material having an average relative permittivity of 13, and particles of a magnetic material, uniformly or non-uniformly dispersed within the dielectric material, having an average relative permeability of 7, having a magnetic loss tangent of 0.10, having an electric loss tangent of 0.006, and having electromagnetic characteristics suitable for use in an EM component 100 as disclosed herein at a range of operating frequencies from equal to or greater than 1 GHz to equal to or less than 2.1 GHz.

Material-F: An MDM having a ceramic based dielectric material having an average relative permittivity of 13, and particles of a magnetic material, uniformly or non-uniformly dispersed within the dielectric material, having an average relative permeability of 5, having a magnetic loss tangent of 0.08, having an electric loss tangent of 0.006, and having electromagnetic characteristics suitable for use in an EM component 100 as disclosed herein at a range of operating frequencies from equal to or greater than 1 GHz to equal to or less than 2 GHz.

Material-G: An MDM having a ceramic based dielectric material having an average relative permittivity of 14.8, and particles of a magnetic material, uniformly or non-uniformly dispersed within the dielectric material, having an average relative permeability of 2, having a magnetic loss tangent of 0.07, having an electric loss tangent of 0.002, and having electromagnetic characteristics suitable for use in an EM component 100 as disclosed herein at a range of operating frequencies from equal to or greater than 500 MHz to equal to or less than 1.5 GHz.

Material-H: An MDM having a ceramic based dielectric material having an average relative permittivity of 14.8, and particles of a magnetic material, uniformly or non-uniformly dispersed within the dielectric material, having an average relative permeability of 2.68, having a magnetic loss tangent of 0.07, having an electric loss tangent of 0.004, and having electromagnetic characteristics suitable for use in an EM component 100 as disclosed herein at a range of operating frequencies from equal to or greater than 1 GHz to equal to or less than 2.5 GHz.

Material-I: An MDM having a ceramic based dielectric material having an average relative permittivity of 14.5, and particles of a magnetic material, uniformly or non-uniformly dispersed within the dielectric material, having an average relative permeability of 1.7, having a magnetic loss tangent of 0.04, having an electric loss tangent of 0.004, and having electromagnetic characteristics suitable for use in an EM component 100 as disclosed herein at a range of operating frequencies from equal to or greater than 1 GHz to equal to or less than 3.5 GHz.

Material-J: An MDM having a ceramic based dielectric material having an average relative permittivity of 14.5, and particles of a magnetic material, uniformly or non-uniformly dispersed within the dielectric material, having an average relative permeability of 1.91, having a magnetic loss tangent of 0.07, having an electric loss tangent of 0.0046 and having electromagnetic characteristics suitable for use in an EM component 100 as disclosed herein at a range of operating frequencies from equal to or greater than 1 GHz to equal to or less than 4.5 GHz.

Material-K: An MDM having a ceramic based dielectric material having an average relative permittivity of 15, and particles of a magnetic material, uniformly or non-uniformly dispersed within the dielectric material, having an average relative permeability of 2.1, having a magnetic loss tangent of 0.05, having an electric loss tangent of 0.006, and having electromagnetic characteristics suitable for use in an EM component 100 as disclosed herein at a range of operating frequencies from equal to or greater than 1 GHz to equal to or less than 3.5 GHz.

Material-L: An MDM having a ceramic based dielectric material having an average relative permittivity of 15, and particles of a magnetic material, uniformly or non-uniformly dispersed within the dielectric material, having an average relative permeability of 2.04, having a magnetic loss tangent of 0.05, having an electric loss tangent of 0.005, and having electromagnetic characteristics suitable for use in an EM component 100 as disclosed herein at a range of operating frequencies from equal to or greater than 1 GHz to equal to or less than 2.5 GHz.

With respect to the above described concentration and dispersion of magnetic material within one or more of the MDMs disclosed herein for the above noted Material-A to Material-D, the following concentrations and/or dispersions are contemplated: a magnetic filler of equal to or greater than 10% volume to equal to or less than 80% volume in a polymer-based composite. Stated alternatively, a magnetic filler in a polymer-based composite where the polymer is equal to or greater than 20% volume and equal to or less than 90% volume. With respect to the above described concentration and dispersion of magnetic material within one or more of the MDMs disclosed herein for the above noted Material-E to Material-L, concentrations and/or dispersions for the major phase of a multi-phase ceramic equal to or greater than 60% volume and equal to or less than 99.9% volume are contemplated.

As used herein and unless otherwise denoted, the term substantially is intended to account for manufacturing tolerances. As such, substantially identical structures are identical if the manufacturing tolerances for producing the corresponding structures are zero.

While embodiments illustrated and described herein depict individual EM components 100, it will be appreciated in the technical field of EM antennas that such EM components 100 may be arranged as an array of EM components 100 in any array configuration suitable for a purpose disclosed herein. As such, any and all arrays of EM components 100 disclosed herein are contemplated and considered to be inherently disclosed herein.

While the foregoing example embodiments are individually presented, it will be appreciated from a complete reading of all of the embodiments described herein that similarities may exist among the individual embodiments that would enable some cross over of features and/or processes. As such, combinations of any of such individual features and/or processes may be employed in accordance with an embodiment, whether or not such combination is explicitly illustrated, while remaining consistent with the disclosure herein. The several figures associated with one or more of the foregoing example embodiments depict an orthogonal set of x-y-z axes that provide a frame of reference for the structural relationship of corresponding features with respect to each other, where an x-y plane coincides with a plan view, and an x-z or y-z plane coincides with an elevation view, of the corresponding embodiments.

While embodiments illustrated and described herein depict MDMs having a particular cross-section profile (x-y, x-z, or y-z), it will be appreciated that such profiles may be modified without departing from a scope of the invention. As such, any profile that falls within the ambit of the disclosure herein, and is suitable for a purpose disclosed herein, is contemplated and considered to be inherently disclosed and complementary to the embodiments disclosed herein.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art.

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” another element, it can be directly on the other element, or intervening elements may also be present. In contrast, when an element is referred to as being “directly on” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The term “comprising” as used herein does not exclude the possible inclusion of one or more additional features. And, any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

1. An electromagnetic, EM, component operational at a defined operating frequency, comprising:
a body of material comprising at least one magneto-dielectric material, MDM, comprising a magnetic material having a relative permeability greater than one and dielectric material having a relative permittivity greater than one, at the defined operating frequency;
wherein the magnetic material has one of: a multi-phase crystal structure; or, a non-cubic crystal structure;
wherein the EM component is at least one of; an EM resonator, and an EM beam shaper.

2. The EM component of claim 1, wherein:
the magnetic material comprises a multi-phase crystal structure.

3. The EM component of claim 2, wherein:
the multi-phase crystal structure is any one of: a cubic structure; a hexagonal structure; or, a mixture of a cubic structure and a hexagonal structure.

4. The EM component of claim 1, wherein:
the magnetic material comprises a single-phase non-cubic crystal structure.

5. The EM component of claim 1, wherein:
the magnetic material comprises a hexaferrite crystal structure.

6. The EM component of claim 5, wherein:
the magnetic material further comprises a single-phase hexaferrite crystal structure.

7. The EM component of claim 5, wherein:
the magnetic material further comprises a multi-phase hexaferrite crystal structure.

8. The EM component of claim 1, wherein:
the magnetic material is dispersed within a polymer dielectric material.

9. The EM component of claim 1, wherein:
the magnetic material is dispersed within a ceramic dielectric material.

10. The EM component of claim 8, wherein:
the magnetic material is uniformly dispersed in the dielectric material.

11. The EM component of claim 8, wherein:
the magnetic material is non-uniformly dispersed in the dielectric material.

12. The EM component of claim 1, wherein:
the magnetic material is other than a single-phase magnetic material.

13. The EM component of claim 1, wherein:
the MDM is a pure magnetic ceramic, including hexagonal structure ferrites, which is a single phase or multiple phases.

14. The EM component of claim 1, wherein:
the EM component comprises the EM resonator, and the EM resonator is an EM antenna.

15. The EM component of claim 1, wherein:
the EM component comprises the EM beam shaper, and the EM beam shaper is an EM lens.

16. The EM component of claim 1, wherein the at least one MDM is configured as an EM resonator so as to receive an EM signal productive of a magnetic field, wherein:
the magnetic material is non-uniformly dispersed within the dielectric material; and
the non-uniformly dispersed magnetic material is more heavily loaded in a region of the body having a relatively higher concentration of the magnetic field as compared to a region of the body having a relatively lower concentration of the magnetic field, in response to the body being electromagnetically excited by the EM signal at the defined operating frequency.

17. The EM component of claim 1, wherein the at least one MDM comprises a first MDM and a second MDM, the first MDM defining an EM resonator; and further wherein:
the second MDM forms an EM beam shaper that substantially covers and embeds EM radiating surfaces of the EM resonator.

18. The EM component of claim 1, wherein the EM component includes the EM resonator; and further comprising:
an EM signal feed configured and disposed to electromagnetically excite the EM resonator via the EM signal.

19. The EM component of claim 18, wherein:
the EM signal feed is disposed inside the first MDM.

20. The EM component of claim 18, wherein:
the EM signal feed is disposed at a boundary of the first MDM and the second MDM.
